(19) United States
(12) Patent Application Publication
(10) Pub. No.: US 2026/0211528 A1
(43) Pub. Date: Jul. 23, 2026

(54) LAMINATED STRUCTURE FILM

(71) Applicant: FUJIFILM Corporation, Tokyo (JP)

(72) Inventor: Makoto KAMO, Minamiashigara-shi (JP)

(73) Assignee: FUJIFILM Corporation, Tokyo (JP)

(21) Appl. No.: 19/571,499

(22) Filed: Mar. 19, 2026

Related U.S. Application Data
(63) Continuation of application No. PCT/JP2024/031894, filed on Sep. 5, 2024.

(30) Foreign Application Priority Data
Sep. 28, 2023 (JP) 2023-167507

(51) Int. Cl. G06F 3/044; G06F 3/041

(52) U.S. Cl. CPC G06F 3/0445; G06F 3/0412; G06F 3/0446; G06F 2203/04112

(57) ABSTRACT

A laminated structure film integrates a touch sensor and a display component. The film includes a support, a first conductive layer on one surface of the support, a second conductive layer on an opposite surface, an insulating layer covering the second conductive layer, a transparent electrode layer on the insulating layer, and a structure layer on the transparent electrode layer. The first and second conductive layers have mesh patterns. The structure layer comprises a visible-light-transparent resin and includes multiple regions partitioned by walls and independent from each other. The insulating layer includes an inorganic layer containing an oxide, nitride, oxynitride, or carbonized oxide including Si, Al, Ti, or Zr, with a thickness of 0.02 to 2 μm.

### CROSS-REFERENCE TO RELATED APPLICATIONS

This application is a Continuation of PCT International Application No. PCT/JP2024/031894 filed on Sep. 5, 2024, which claims priority under 35 U.S.C. § 119(a) to Japanese Patent Application No. 2023-167507 filed on Sep. 28, 2023. The above applications are hereby expressly incorporated by reference, in their entirety, into the present application.

### BACKGROUND OF THE INVENTION

### 1. Field of the Invention

The present invention relates to a laminated structure film having a support provided with conductive layers on both surfaces and a structure layer having a plurality of regions partitioned by partition walls, and particularly relates to a laminated structure film in which a touch sensor function and a display function are partially integrated.

### 2. Description of the Related Art

Currently, a touch sensor is used as an input device. The touch sensor is incorporated into various electronic devices including portable information devices such as a tablet computer and a smartphone. An input operation to an electronic device is carried out by bringing a finger, a stylus pen, or the like into contact with or close to the touch sensor.

For example, JP2014-115694A describes a capacitance type touch panel. The touch panel of JP2014-115694A includes a substrate having optical transmittance, a plurality of mesh-shaped first electrode patterns that are provided on a first main surface of the substrate and are connected to each other along a first direction, a plurality of mesh-shaped second electrode patterns that are provided on the first main surface and are arranged at intervals from each other along a second direction intersecting the first direction, a jumper insulating layer that is provided on the first main surface so as to cover intersections between the meshes of the first electrode patterns connected to each other, and a jumper wiring that is provided on the jumper insulating layer and electrically connects the second electrode patterns adjacent to each other. The first electrode patterns connected to each other along the first direction are electrically connected at the intersections.

### SUMMARY OF THE INVENTION

As described above, the touch sensor is incorporated into the electronic device, but is simply disposed on a surface of a display device such as an LCD of the electronic device, and the touch sensor and the display device are separate bodies. Currently, there is a demand for functional integration of a touch sensor and a display device, but at present there is no device that has functional integration of a touch sensor and a display device.

An object of the present invention is to provide a laminated structure film that integrates a touch sensor and a part of a display device.

The above-mentioned object can be achieved by the following configurations.

Invention [1] is a laminated structure film including a support, a first conductive layer provided on one surface of the support, a second conductive layer provided on the other surface of the support opposite to the one surface, an insulating layer provided on the other surface of the support to cover the second conductive layer, a transparent electrode layer provided on the insulating layer, and a structure layer provided on the transparent electrode layer, in which the first conductive layer and the second conductive layer have a mesh pattern, the structure layer is composed of a resin material that is transparent to visible light, the structure layer has a plurality of regions that are partitioned by partition walls and are independent from each other, the insulating layer includes an inorganic layer composed of an oxide, a nitride, an oxynitride, or a carbonized oxide, each containing an element selected from Si, Al, Ti, and Zr, and the inorganic layer has a thickness of 0.02 to 2 μm.

Invention [2] is the laminated structure film according to Invention [1], in which the insulating layer has a single layer configuration of the inorganic layer containing polysilazane.

Invention [3] is the laminated structure film according to Invention [1] or [2], in which the inorganic layer contains the oxynitride on a surface thereof.

Invention [4] is the laminated structure film according to any one of Inventions [1] to [3], in which the region of the structure layer is a concave portion that is configured to be surrounded by the partition wall, and in the concave portion, a distance in a thickness direction of the transparent electrode layer from a bottom surface of the concave portion to an end of the partition wall on a side opposite to the bottom surface is 20 to 50 μm.

According to the present invention, it is possible to provide a laminated structure film that integrates a touch sensor and a part of a display device.

### BRIEF DESCRIPTION OF THE DRAWINGS

FIG. 1 is a schematic cross-sectional view showing an example of an image display device having a laminated structure film according to an embodiment of the present invention.

FIG. 2 is a schematic view showing an example of a touch sensor of the laminated structure film according to the embodiment of the present invention.

FIG. 3 is a schematic view showing an example of an electrode configuration of a detection unit of a touch sensor.

FIG. 4 is a schematic view showing an example of a shape of a mesh pattern of a touch sensor.

FIG. 5 is a schematic view showing an example of a pattern of a partition wall of a structure layer of the laminated structure film according to the embodiment of the present invention.

FIG. 6 is a schematic cross-sectional view showing one step of a manufacturing method of the laminated structure film according to the embodiment of the present invention.

FIG. 7 is a schematic cross-sectional view showing one step of the manufacturing method of the laminated structure film according to the embodiment of the present invention.

FIG. 8 is a schematic cross-sectional view showing one step of the manufacturing method of the laminated structure film according to the embodiment of the present invention.

FIG. 9 is a schematic cross-sectional view showing one step of the manufacturing method of the laminated structure film according to the embodiment of the present invention.

FIG. 10 is a schematic cross-sectional view showing one step of the manufacturing method of the laminated structure film according to the embodiment of the present invention.

### DESCRIPTION OF THE PREFERRED EMBODIMENTS

Hereinafter, the laminated structure film according to the embodiment of the present invention will be described in more detail based on suitable embodiments shown in the accompanying drawings.

The drawings to be described below are only illustrative for explaining the present invention, and the present invention is not limited to the drawings to be shown below.

In the following description, the expression “to” indicating a numerical range includes numerical values written on both sides of “to”. For example, in a case where ε is a value of a numerical value ε_{α} to a numerical value ε_{β}, the range of ε is a range including the numerical value Ex and the numerical value ε_{β} and is expressed by ε_{α}≤ε≤ε_{β} in mathematical symbols.

Unless otherwise specified, angles such as “parallel” and “orthogonal” include a generally accepted error range in the relevant technical field.

Unless otherwise specified, the term “transparent” is intended to mean that the light transmittance is 40% or more, preferably 80% or more, and more preferably 90% or more in a visible light wavelength range of 380 to 780 nm. In addition, in the following description, unless otherwise specified, the term “transparent” indicates that it is transparent to visible light, that is, light in a wavelength range of 380 to 780 nm.

The light transmittance is measured using “Plastics-Determination of total light transmittance and total light reflectance” as specified in Japanese Industrial Standards (JIS) K 7375:2008.

### [Image Display Device]

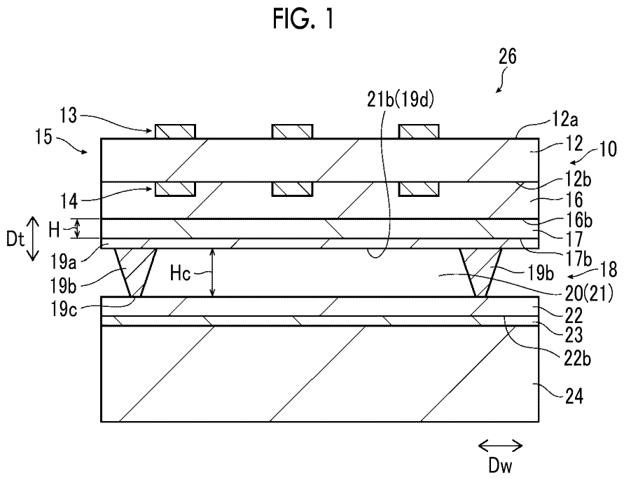

FIG. 1 is a schematic cross-sectional view showing an example of an image display device having a laminated structure film according to the embodiment of the present invention. An image display device 26 has a laminated structure film 10, a sealing layer 22, an adhesion layer 23, and a drive circuit board 24.

### (Laminated Structure Film)

The laminated structure film 10 has a support 12, a first conductive layer 13 provided on one surface 12a of the support 12, a second conductive layer 14 provided on the other surface 12b of the support 12 opposite to the one surface 12a, an insulating layer 16 provided on the other surface 12b of the support 12 to cover the second conductive layer 14, a transparent electrode layer 17 provided on the insulating layer 16, and a structure layer 18 provided on the transparent electrode layer 17.

The first conductive layer 13 and the second conductive layer 14 have a mesh pattern (see FIG. 4).

A touch sensor 15 is composed of the support 12, the first conductive layer 13, and the second conductive layer 14. The one surface 12a side of the support 12 is a side of the touch sensor 15 that comes into contact with a finger, a stylus pen, or the like.

The touch sensor 15 has a configuration other than the support 12, the first conductive layer 13, and the second conductive layer 14. The touch sensor 15 will be described in more detail later.

The transparent electrode layer 17 is provided on a surface 16b of the insulating layer 16. The surface 16b of the insulating layer 16 is the surface of the insulating layer 16 opposite to the support 12.

The structure layer 18 is composed of a resin material that is transparent to visible light. The structure layer 18 has a base 19a and a partition wall 19b provided on the base 19a.

The base 19a of the structure layer 18 is provided on a surface 17b of the transparent electrode layer 17. The surface 17b of the transparent electrode layer 17 is the surface of the transparent electrode layer 17 opposite to the support 12.

The structure layer 18 has a plurality of regions 20 that are partitioned by the partition walls 19b and are independent from each other. The region 20 is a concave portion 21 that is configured to be surrounded by the partition wall 19b. The concave portion 21 functions as a pixel of a display device as will be described later.

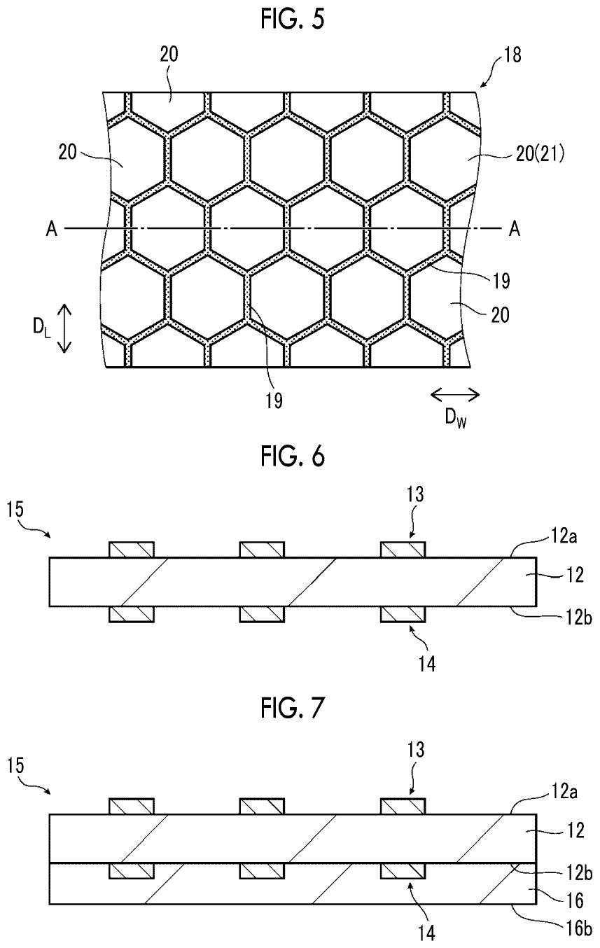

Although not shown in FIG. 1, the partition wall 19b extends. FIG. 1 shows a cross section in a direction Dw orthogonal to an extending direction DL of the partition wall 19b (see FIG. 5). The cross section of the structure layer 18 shown in FIG. 1 corresponds to a cross section taken along line A-A of FIG. 5.

The partition wall 19b has, for example, a trapezoidal shape in which an end 19c is flat and the end 19c is narrower than the base 19a in the cross-sectional shape shown in FIG. 1. The direction Dw is also a direction orthogonal to a thickness direction Dt of the transparent electrode layer 17. The partition walls 19b are disposed side by side in the direction Dw. The thickness direction Dt of the transparent electrode layer 17, the extending direction DL of the partition wall 19b (see FIG. 5), and the direction Dw are orthogonal to one another.

As described above, the laminated structure film 10 has a configuration in which the support 12 having the first conductive layer 13 and the second conductive layer 14 provided on each surface, the transparent electrode layer 17, and the structure layer 18 are provided with the insulating layer 16 interposed therebetween, whereby a touch sensor and a part of a display device can be integrated.

A sealing layer 22 is provided on the opposite side of the structure layer 18 from the base 19a to close the opening of the concave portion 21. The adhesion layer 23 is provided on a surface 22b of the sealing layer 22. The drive circuit board 24 is adhered to the sealing layer 22 by the adhesion layer 23. In this manner, the image display device 26 is configured. The surface 22b of the sealing layer 22 is the surface of the sealing layer 22 opposite to the structure layer 18.

Further, a controller (not shown) of the touch sensor 15 is provided. The concave portion 21 of the structure layer 18 is filled with, for example, an electrophoretic ink composition (not shown). As a result, the concave portion 21 of the structure layer 18 functions as a pixel of a display device, a display image is obtained as will be described later, and the image display device 26 in which the touch sensor 15 and the display device are combined is configured.

The above-mentioned drive circuit board 24 has, for example, an electrode (not shown) for applying an electric field to the concave portion 21 of the structure layer 18 using the transparent electrode layer 17 as a common electrode, and a thin film transistor (TFT) for controlling a voltage applied to the electrode. In addition, the drive circuit board 24 is provided with a controller which is not shown. The TFT of the drive circuit board 24 is controlled by the controller, and the voltage applied to the electrode is controlled. For example, a voltage is applied to the electrode to generate an electric field between the transparent electrode layer 17 and the electrode, and the electric field is applied to the concave portion 21 of the structure layer 18. The electric field applied to each of the concave portions 21 is controlled, and the movement of the electrophoretic ink composition filled in each of the concave portions 21 is controlled to form a display image.

In the image display device 26, the laminated structure film 10 is configured so that a display image (not shown) displayed by the concave portion 21 can be visually recognized.

In addition, for example, a protective layer (not shown) that covers the first conductive layer 13 is provided on one surface 12a of the support 12. In this case, the surface of the protective layer is a touch surface of the image display device 26 and serves as an operation surface.

The protective layer is not particularly limited in a configuration thereof as long as it is transparent and has electrical insulating properties. For example, an optically transparent resin (optical clear resin: OCR) such as an ultraviolet (UV) curable resin can be used as the protective layer.

The controller of the touch sensor 15 described above is configured by a known controller used for detection by the touch sensor 15. In a case where the touch sensor 15 is of a capacitance type, the controller detects a position where the capacitance changes due to contact of a finger or the like with the touch surface. The capacitance type touch sensor includes, but is not particularly limited to, a mutual capacitance type touch sensor and a self-capacitance type touch sensor.

In a case where the touch sensor 15 is of a resistive membrane type, the controller detects a position where the resistance changes due to contact of a finger or the like with the touch surface.

The image display device 26 may further have a cover layer (not shown) provided on a surface of the protective layer (not shown). In this case, the surface of the cover layer is a touch surface of the image display device 26 and serves as an operation surface. In this case, the surface of the cover layer is subjected to an input operation as the operation surface. The touch surface is a surface that detects contact with a finger, a stylus pen, or the like. The surface of the cover layer serves as a visible surface of a display image (not shown). In a case where the cover layer is composed of glass, it is referred to as a cover glass.

The cover layer protects the laminated structure film 10. The cover layer is not particularly limited in a configuration thereof. The cover layer is preferably transparent such that a display image (not shown) can be visually recognized. For example, a plastic film, a plastic plate, a glass plate, or the like is used as the cover layer. It is preferable that the thickness of the cover layer is selected as appropriate depending on the applications.

As raw materials of the above-mentioned plastic film and plastic plate, for example, polyesters such as polyethylene terephthalate (PET) and polyethylene naphthalate (PEN); polyolefins such as polyethylene (PE), polypropylene (PP), polystyrene, and vinyl acetate copolymerized polyethylene (EVA); vinyl-based resins; and other materials such as a polycarbonate (PC), polyamide, polyimide, an acrylic resin, triacetyl cellulose (TAC), a cycloolefin-based resin (COP), polyvinylidene fluoride (PVDF), polyarylate (PAR), polyether sulfone (PES), a polymer acrylic resin, a fluorene derivative, and crystalline COP can be used.

In addition, a polarizing plate, a circular polarization plate, or the like may be used as the cover layer.

Since the surface of the cover layer serves as the touch surface as described above, a hard coat layer may be provided on the surface as necessary. The thickness of the cover layer is, for example, 0.1 to 1.3 mm, and particularly preferably 0.1 to 0.7 mm.

In addition, the laminated structure film 10 may have a hard coat layer (not shown) provided between the insulating layer 16 and the transparent electrode layer 17. This increases the adhesiveness between the insulating layer 16 and the transparent electrode layer 17. The hard coat layer is composed of, for example, an ultraviolet curable resin.

### (Touch Sensor)

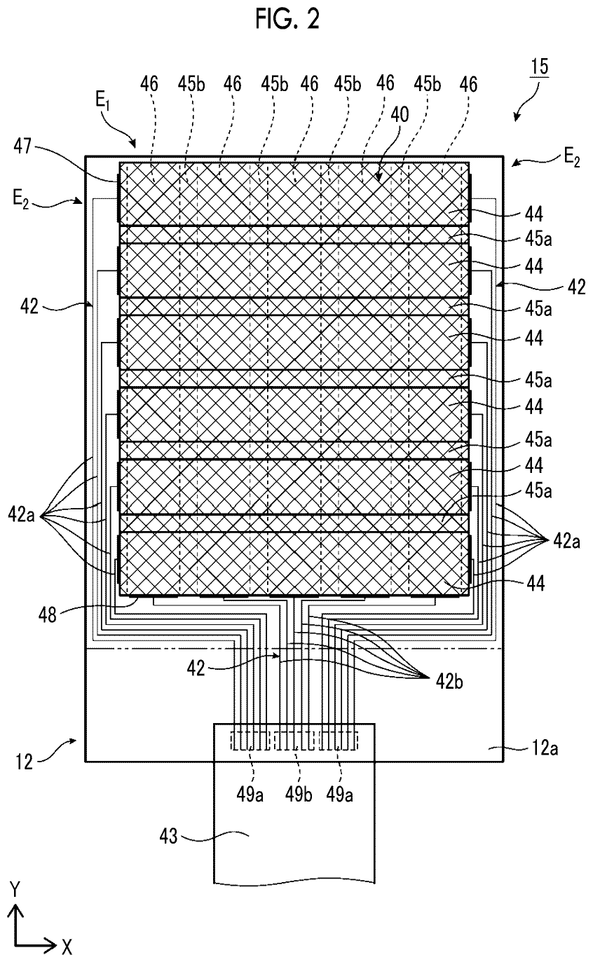

Next, the touch sensor 15 in which the first conductive layer 13 and the second conductive layer 14 are provided on both surfaces of the support 12 will be described with reference to FIG. 2 to FIG. 4.

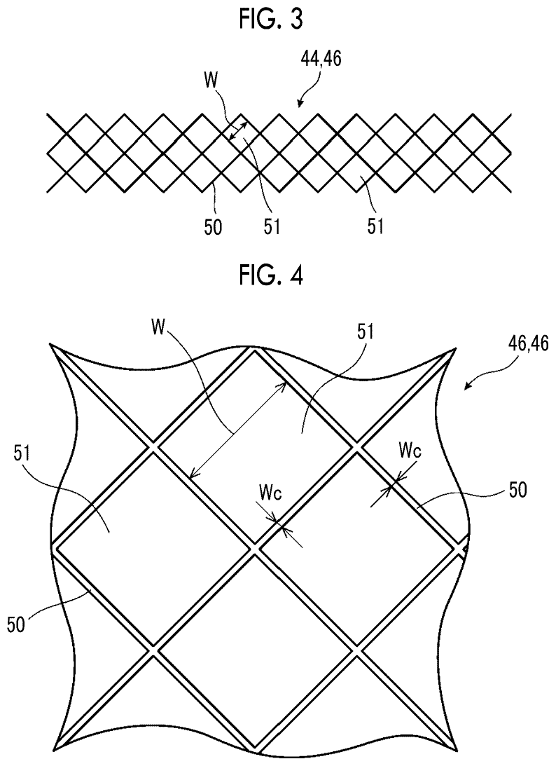

FIG. 2 is a schematic view showing an example of the touch sensor of the laminated structure film according to the embodiment of the present invention, and FIG. 3 is a schematic view showing an example of an electrode configuration of a detection unit of the touch sensor. FIG. 4 is a schematic view showing an example of a shape of a mesh pattern of the touch sensor. In FIG. 2 to FIG. 4, the same components as those of the laminated structure film 10 shown in FIG. 1 are denoted by the same reference numerals, and detailed description thereof will be omitted.

The touch sensor 15 shown in FIG. 2 is a part of the laminated structure film 10, and is a portion that functions as a detection sensor in the laminated structure film 10.

The touch sensor 15 has a detection region E₁ in which an input operation can be carried out by a user and a peripheral region E₂ positioned outside the detection region E₁. The detection region E₁ is disposed in a display region of a display device or the like, and the peripheral region E₂ positioned outside the detection region E₁ is disposed in a non-display region of the display device or the like.

The first conductive layer 13 and the second conductive layer 14 are electrically insulated by the support 12. The support 12 functions as an electrical insulating layer.

The first conductive layer 13 and the second conductive layer 14 each have a detection unit 40 and a peripheral wiring unit 42.

The detection unit 40 has, for example, a plurality of first detection electrodes 44 and a plurality of first dummy electrodes 45a that are disposed between the first detection electrodes 44 adjacent to each other and are insulated from the first detection electrodes 44.

In addition, the detection unit 40 has, for example, a plurality of second detection electrodes 46 and a plurality of second dummy electrodes 45b that are disposed between the second detection electrodes 46 adjacent to each other and are insulated from the second detection electrodes 46.

The peripheral wiring unit 42 has a first peripheral wiring 42a which is a wiring for transmitting or transferring a touch drive signal and a touch detection signal from a controller (not shown) to the first detection electrode 44.

In addition, the peripheral wiring unit 42 has a second peripheral wiring 42b which is a wiring for transmitting or transferring a touch drive signal and a touch detection signal from a controller (not shown) to the second detection electrode 46.

The plurality of first detection electrodes 44 are strip-shaped electrodes that extend in parallel to each other in an X direction, and are provided on one surface 12a of the support 12 at intervals from each other in a Y direction orthogonal to the X direction and in a state of being electrically insulated from each other in the Y direction.

In addition, the plurality of first dummy electrodes 45a are provided on one surface 12a of the support 12 in a state of being disposed between the first detection electrodes 44 and being electrically insulated from the first detection electrodes 44. A first electrode terminal 47 is provided at at least one end of each of the first detection electrodes 44 in the X direction.

The plurality of second detection electrodes 46 are strip-shaped electrodes that extend in parallel to each other in the Y direction and are provided on the other surface 12b of the support 12 (see FIG. 1) at intervals from each other in the X direction and in a state of being electrically insulated from each other in the X direction.

In addition, the plurality of second dummy electrodes 45b are provided on the other surface 12b of the support 12 (see FIG. 1) in a state of being disposed between the second detection electrodes 46 and being electrically insulated from the second detection electrodes 46. A second electrode terminal 48 is provided at one end of each of the second detection electrodes 46 in the Y direction.

The plurality of first detection electrodes 44 and the plurality of second detection electrodes 46 are provided orthogonal to each other, but are electrically insulated from each other by the support 12 as described above.

The first dummy electrode 45a and the second dummy electrode 45b in the first detection electrode 44 and the second detection electrode 46 are regions that are separated from the first detection electrode 44 or the second detection electrode 46 by a disconnection portion and are not electrically connected. Therefore, as described above, the plurality of first detection electrodes 44 are in a state of being electrically insulated from each other in the Y direction, and the plurality of second detection electrodes 46 are in a state of being electrically insulated from each other in the X direction. As shown in FIG. 2, six first detection electrodes 44 and five second detection electrodes 46 are provided in the detection unit 40, but the numbers thereof are not particularly limited as long as they are plural.

The first conductive layer 13 and the second conductive layer 14 are composed of, for example, conductive thin wires 50. The first conductive layer 13 and the second conductive layer 14 have a mesh pattern (see FIG. 3 and FIG. 4), but the mesh pattern is composed of the conductive thin wires 50.

The first detection electrode 44 and the second detection electrode 46 are mesh-shaped electrodes having a mesh pattern made of the conductive thin wires 50. In this case, the first dummy electrode 45a and the second dummy electrode 45b are also mesh-shaped dummy electrodes having a mesh pattern made of the conductive thin wires 50.

The electrode width of the first detection electrode 44 and the electrode width of the second detection electrode 46 are each, for example, 1 to 5 mm, and the inter-electrode pitch is 3 to 6 mm. The electrode width of the first detection electrode 44 is denoted as the maximum length in the Y direction and the electrode width of the second detection electrode 46 is denoted as the maximum length in the X direction.

In the peripheral wiring unit 42, one end of the first peripheral wiring 42a is electrically connected to the first detection electrode 44 through the first electrode terminal 47, and the other end of the first peripheral wiring 42a is electrically connected to a first external connection terminal 49a. In addition, one end of the second peripheral wiring 42b is electrically connected to the second detection electrode 46 through the second electrode terminal 48, and the other end of the second peripheral wiring 42b is electrically connected to a second external connection terminal 49b.

A flexible circuit board 43 is electrically connected to the first external connection terminal 49a and the second external connection terminal 49b. The flexible circuit board 43 is electrically connected to the above-mentioned controller (not shown).

The first peripheral wiring 42a and the second peripheral wiring 42b can also have the same configuration as the first detection electrode 44 and the second detection electrode 46 and are composed of the conductive thin wires 50.

The first electrode terminal 47 and the second electrode terminal 48 may have a fill-in film shape or may have a mesh shape as shown in JP2013-127658A. The preferred range of the width of each of the first electrode terminal 47 and the second electrode terminal 48 is ⅓ times or more and 1.2 times or less with respect to the electrode width of each of the first detection electrode 44 and the second detection electrode 46.

In the first conductive layer 13 and the second conductive layer 14, it is preferable that the detection unit 40 and the peripheral wiring unit 42 are integrally configured from the viewpoints of electrical resistance and difficulty in occurrence of disconnection, and it is more preferable that the detection unit 40 and the peripheral wiring unit 42 are formed of the same metal material.

Hereinafter, each part of the laminated structure film will be described.

### <Support>

The support supports the first conductive layer and the second conductive layer, and electrically insulates the first conductive layer 13 from the second conductive layer 14 as described above. The support is not particularly limited as long as it can support the first conductive layer and the second conductive layer and can electrically insulate the first conductive layer 13 from the second conductive layer 14. For example, a resin substrate or a glass substrate is used as the support. More specifically, for example, glass, reinforced glass, alkali-free glass, polyethylene terephthalate (PET), polyethylene naphthalate (PEN), a cyclo-olefin polymer (COP), a cyclic olefin copolymer (COC), polycarbonate (PC), an acrylic resin, polyethylene (PE), polypropylene (PP), polystyrene (PS), polyvinyl chloride (PVC), polyvinylidene chloride (PVDC), or cellulose triacetate (TAC) can be used as the material constituting the support. The thickness of the support is, for example, preferably 20 μm to 1100 μm, and more preferably 20 μm to 500 μm. In particular, in a case of an organic resin substrate such as PET, the thickness of the support is preferably 20 μm to 200 μm, and more preferably 30 μm to 100 μm.

The total light transmittance of the support is preferably 40% to 100%, and more preferably 85% to 100%. That is, the support is preferably transparent to visible light. The total light transmittance is measured using, for example, “Plastics-Determination of total light transmittance and total light reflectance” as specified in Japanese Industrial Standards (JIS) K 7375:2008.

One of suitable aspects of the support is, for example, a treated substrate that has been subjected to at least one treatment selected from the group consisting of an atmospheric pressure plasma treatment, a corona discharge treatment, and an ultraviolet irradiation treatment. By carrying out the above-mentioned treatment, a hydrophilic group such as an OH group is introduced into the surface of the treated support. This improves the adhesiveness between the support and the first conductive layer and the adhesiveness between the support and the second conductive layer. In addition, among the above-mentioned treatments, an atmospheric pressure plasma treatment is preferable from the viewpoint of further improving the adhesiveness between the support and the first conductive layer and the adhesiveness between the support and the second conductive layer.

### <Undercoat Layer>

In order to improve the adhesiveness between the support and the first conductive layer and the adhesiveness between the support and the second conductive layer, an undercoat layer can be disposed between the support and the first conductive layer and between the support and the second conductive layer, respectively. This undercoat layer contains a polymer, which further improves the adhesiveness between the support and the first conductive layer and the adhesiveness between the support and the second conductive layer.

The method for forming the undercoat layer is not particularly limited, and examples thereof include a method in which a composition for forming an undercoat layer containing a polymer is applied onto a substrate, and as necessary, a heat treatment is carried out thereon. In addition, gelatin, an acrylic resin, a urethane resin, an acrylic styrene-based latex containing inorganic or polymeric fine particles, or the like may be used as the composition for forming an undercoat layer containing a polymer.

In addition, as necessary, a refractive index-adjusting layer may be provided as another layer between the support and the first conductive layer and between the support and the second conductive layer, respectively, in addition to the above-mentioned undercoat layer. For example, an organic layer to which particles of a metal oxide such as zirconium oxide that adjusts a refractive index have been added can be used as the refractive index-adjusting layer.

### <Conductive Thin Wires>

The conductive thin wires 50 constitute the first conductive layer 13 (see FIG. 1) and the second conductive layer 14 (see FIG. 1) as described above. The conductive thin wires 50 constitute the first detection electrode 44 (see FIG. 2), the first peripheral wiring 42a (see FIG. 2), the second detection electrode 46 (see FIG. 2), and the second peripheral wiring 42b (see FIG. 2). As shown in FIG. 4, a mesh pattern is composed of linear conductive thin wires 50.

The thickness of the conductive thin wires 50 is preferably 350 to 1000 nm, and more preferably 600 to 900 nm. In a case where the thickness of the conductive thin wires 50 is 350 to 1000 nm, the electric resistance of the conductive thin wires 50 is smaller. In a case where the thickness of the conductive thin wires 50 is 600 to 900 nm, the electric resistance of the conductive thin wires 50 is further reduced, which is more preferable. In addition, in a case where the thickness of the conductive thin wires 50 is large, the number of voids increases and the bendability is improved, so it is preferable that the thickness of the conductive thin wires 50 is large.

The width Wc of the conductive thin wires 50 (see FIG. 4) is preferably 1.5 to 4.0 μm, more preferably 1.5 to 3.0 μm, and still more preferably 1.5 to 2.5 μm. In a case where the width Wc of the conductive thin wires 50 is 1.5 to 4.0 μm, the conductive thin wires 50 are less likely to be visible, and the occurrence of moire or the like is also suppressed. That is, the visibility is excellent. In addition, in a case where the width Wc of the conductive thin wires 50 is small, the number of voids increases and the bendability is improved, so it is preferable that the width Wc of the conductive thin wires 50 is small.

The thickness of the conductive thin wires 50 and the width Wc of the conductive thin wires 50 are measured by cutting the first conductive layer 13, the support 12, and the second conductive layer 14 and using a cross-sectional image of the cut cross section under a scanning electron microscope (SEM). In the cross-sectional image, for an image region corresponding to the conductive thin wires 50, the length corresponding to the thickness and the width Wc of the conductive thin wires 50 is measured at 10 points, and an average value of the measured values at the 10 points is obtained. The thickness and the width Wc of the conductive thin wires 50 are each an average value of the measured values at the above-mentioned 10 points.

The conductive thin wires constituting the first conductive layer and the second conductive layer are not particularly limited as long as the conductive thin wires are made of a material having conductivity. The conductive thin wires are composed of, for example, a material containing metallic silver and a polymer binder such as gelatin or acrylic styrene-based latex. In addition, the conductive thin wires are composed of a metal as will be described later. In addition, the conductive thin wires can also be composed of a material containing metal oxide particles, metal pastes such as a silver paste and a copper paste, and metal nanowire particles such as silver nanowires and copper nanowires.

### <<Fine Metal Wire>>

The conductive thin wires are composed of, for example, a metal. In this case, the conductive thin wires are fine metal wires. In a case of a fine metal wire, the fine metal wire is composed of, for example, a metal such as gold (Au), silver (Ag), copper (Cu), aluminum (Al), molybdenum (Mo), or titanium (Ti), or an alloy thereof. Above all, from the viewpoint of excellent conductivity, the fine metal wire is preferably composed of silver or copper, and more preferably copper or a copper alloy. In addition, the fine metal wire is not limited to being composed of a metal simple substance, and may have a multilayer structure of only a metal that does not include a layer of an oxide or the like. For example, a laminated structure of molybdenum, copper, and molybdenum, or a laminated structure of molybdenum, aluminum, and molybdenum can be exemplified.

In a case where the fine metal wire is composed of copper, examples of the copper material include a copper simple substance (metallic copper) and a mixture containing copper and a metal other than copper (a copper alloy), among which a copper simple substance is preferable. Examples of the metal other than copper contained in the copper alloy include silver, gold, aluminum, nickel, molybdenum, chromium, and palladium.

### <<Blackening Layer>>

The blackening layer reduces the reflectivity of the conductive thin wires, for example, and is particularly effective in a case where the conductive thin wires are made of a metal. The blackening layer can be composed of copper nitride, copper oxide, copper oxynitride, molybdenum oxide, AgO, Pd, carbon, or other nitrides or oxides. The blackening layer is formed on the surface of the conductive thin wires disposed on the visible side of the conductive thin wires, that is, on the one surface 12a side of the support 12.

### <<Method for Forming First Conductive Layer and Second Conductive Layer>>

Next, a method for forming the first conductive layer and the second conductive layer will be described. For example, a sputtering method, a plating method, a silver salt method, or a printing method can be appropriately used as the method for forming the first conductive layer and the second conductive layer.

The method for forming the first conductive layer and the second conductive layer by a sputtering method will be described. First, a layer of a conductive material is formed by sputtering, and then the layer of a conductive material is patterned by photolithography, whereby the first conductive layer and the second conductive layer can be formed. The layer of a conductive material can also be formed by so-called vapor deposition instead of sputtering. For the layer of a conductive material, an electrolytic metal foil can be used in addition to carrying out sputtering or vapor deposition. More specifically, a step of forming a copper wiring described in JP2014-029614A can be used.

A method for forming the first conductive layer and the second conductive layer by a plating method will be described. For example, the first conductive layer and the second conductive layer can be configured using a metal plating film that is formed on an electroless plating underlayer by carrying out electroless plating on the underlayer. In this case, the first conductive layer and the second conductive layer are formed by forming a catalyst ink containing at least metal fine particles on a substrate in a patterned manner and then immersing the substrate in an electroless plating bath to form a metal plating film. More specifically, the manufacturing method of a metal-coated substrate described in JP2014-159620A can be used.

In addition, the first conductive layer and the second conductive layer are formed by forming a resin composition having a functional group capable of interacting with at least a metal catalyst precursor on a substrate in a patterned manner, applying a catalyst or a catalyst precursor thereto, and then immersing the substrate in an electroless plating bath to form a metal plating film. More specifically, the manufacturing method of a metal-coated substrate described in JP2012-144761A can be applied. In addition, the first conductive layer and the second conductive layer may be formed by carrying out electroless plating on a wiring pattern formed by a silver salt method. In this case, the first conductive layer and the second conductive layer are formed in such a manner that a pattern consisting of silver particles, which is formed by a step including a step of exposing and developing a film onto which a photographic material is applied and, optionally further removing gelatin, is subjected to electroless silver or copper plating to form a metal plating film. More specifically, the manufacturing methods described in WO2020/158494A, WO2021/059812A, and WO2021/065226A can be applied.

A method for forming the first conductive layer and the second conductive layer by a silver salt method will be described. First, a silver salt emulsion layer containing silver halide is subjected to an exposure treatment using an exposure pattern for forming the first conductive layer and the second conductive layer, and then a development treatment is carried out, whereby the first conductive layer and the second conductive layer can be formed. More specifically, the manufacturing methods of the first conductive layer and the second conductive layer described in JP2012-006377A, JP2014-112512A, JP2014-209332A, JP2015-022397A, JP2016-192200A, and WO2016/157585A can be used.

A method for forming the first conductive layer and the second conductive layer by a printing method will be described. First, a conductive paste containing conductive powder is applied onto a substrate in the same pattern as the first conductive layer and the second conductive layer, and then a heat treatment is carried out, whereby the first conductive layer and the second conductive layer can be formed. The pattern formation using the conductive paste is carried out by, for example, an inkjet method or a screen printing method. More specifically, the conductive paste described in JP2011-028985A can be used as the conductive paste.

In addition, fine metal wires are formed as the conductive thin wires using the above-mentioned method for forming the first conductive layer and the second conductive layer.

In addition, as the method for forming the first conductive layer and the second conductive layer, for example, a method of obtaining a conductive pattern by carrying out a treatment on a conductive material precursor in a film as in JP2013-012604A, JP2020-017381A, or the like can be used. In addition, a method for forming a layer containing conductive fine particles in a patterned manner as in JP2013-225489A, a method of applying a plating layer in a patterned manner on a resin layer as in JP2006-222163A, and the like can also be used for the method for forming the first conductive layer and the second conductive layer.

### <<Mesh Pattern>>

As described above, the first detection electrode 44 and the second detection electrode 46 have a mesh pattern (see FIG. 3 and FIG. 4) in which a plurality of linear conductive thin wires 50 intersect each other.

From the viewpoint of visible light transmittance, the mesh pattern composed of the conductive thin wires 50 has an opening ratio of preferably 90% or more, and more preferably 95% or more. The opening ratio corresponds to a proportion of the transmissive portion excluding the conductive thin wires in the region where the conductive layer is provided, that is, the opening portion to the entire region where the conductive layer is provided.

The first peripheral wiring 42a and the second peripheral wiring 42b may have a mesh pattern in which a plurality of the conductive thin wires 50 intersect with each other.

In a case where the first detection electrode 44 and the second detection electrode 46 as well as the first peripheral wiring 42a and the second peripheral wiring 42b are configured to have a mesh pattern, the pattern of the mesh pattern is not particularly limited and is preferably a geometric shape that is obtained by combining a triangle such as a regular triangle, an isosceles triangle, or a right triangle, a quadrangle such as a square, a rectangle, a rhombus, a parallelogram, or a trapezoid, an (regular) n-polygon such as a (regular) hexagon or a (regular) octagon, a circle, an ellipse, and a star shape.

The mesh of the mesh pattern is intended to refer to a shape including a plurality of opening portions 51 composed of the intersecting conductive thin wires 50. The opening portion 51 is an opening region surrounded by the conductive thin wires 50. In FIG. 3, the opening portion 51 has a rhombus shape, but may have other shapes. For example, the shape of the opening portion 51 may be a polygonal shape (for example, a triangular shape, a quadrangular shape, a hexagonal shape, or a random polygonal shape). In addition, the shape of one side may be a curved shape or may be an arc shape, in addition to a linear shape. In a case of an arc shape, for example, two sides facing each other may have an arc shape that is outwardly convex, and the other two sides facing each other may have an arc shape that is inwardly convex. In addition, the shape of each of the sides may be a wavy line shape in which an arc that is outwardly convex and an arc that is inwardly convex are continuous. Needless to say, the shape of each of the sides may be a sine curve shape. The mesh pattern is not particularly limited, and may be a random pattern or a regular pattern, or may be a regular mesh pattern in which a plurality of congruent shapes are repeatedly disposed.

The mesh pattern is preferably a regular mesh pattern having the same rhombic lattice. The length of one side of the rhombus, that is, the length W of one side of the opening portion 51 (see FIG. 3 and FIG. 4) is preferably 50 to 1500 μm, more preferably 150 to 800 μm, and still more preferably 200 to 600 μm from the viewpoint of visibility. In a case where the length W of one side of the opening portion 51 is in the above-mentioned range, transparency can be further favorably maintained, and the display image can be visually recognized without any sense of incongruity on the laminated structure film 10 (see FIG. 1).

The mesh pattern of the conductive thin wires can be observed and measured using an optical microscope (Digital Microscope VHX-7000, manufactured by Keyence Corporation).

### <Insulating Layer>

The insulating layer 16 electrically insulates the second conductive layer 14 of the support 12 from the transparent electrode layer 17. In addition, the insulating layer 16 serves to prevent moisture from penetrating into the transparent electrode layer and the structure layer.

The insulating layer includes an inorganic layer composed of an oxide, a nitride, an oxynitride, or a carbonized oxide, each containing an element selected from Si, Al, Ti, and Zr. Specifically, the insulating layer includes an inorganic layer composed of a silicon oxide, a silicon nitride, a silicon oxynitride, an aluminum oxide, an aluminum nitride, an aluminum oxynitride, a titanium oxide, a titanium nitride, a titanium oxynitride, a zirconium oxide, a zirconium nitride, or a zirconium oxynitride.

By including the above-mentioned inorganic layer, the insulating layer can realize the above-mentioned electrical insulation and prevention of the penetration of moisture.

In addition, the insulating layer can also be composed of an inorganic layer having, for example, a silicon nitride and a silicon oxynitride. In this case, the silicon oxynitride is contained on the surface of the inorganic layer, that is, on the surface 16b of the insulating layer 16 (see FIG. 1).

A thickness H of the inorganic layer (see FIG. 1) is 0.02 μm (20 nm) to 2 μm. In a case where the thickness of the inorganic layer is 0.02 to 2 μm, it is possible to realize the above-mentioned electrical insulation and prevention of the penetration of moisture without increasing the thickness of the laminated structure film.

The thickness H of the inorganic layer (see FIG. 1) is measured by cutting the laminated structure film 10 and using a cross-sectional image of the cut cross section taken with a scanning electron microscope. In the cross-sectional image, for an image region corresponding to the insulating layer 16, the length corresponding to the thickness H of the insulating layer 16 is measured at 10 points, and an average value of the measured values at the 10 points is obtained. The thickness H of the insulating layer 16 is an average value of the measured values at the above-mentioned 10 points.

The method for forming the insulating layer is not particularly limited. The method for forming the insulating layer may be, for example, a method of applying a composition containing an insulating material or a precursor thereof, followed by removal of volatile components, heating, exposure, or the like, as necessary. In addition to this method, other examples of the method for forming the insulating layer include a vapor deposition method and a sputtering method. In the laminated structure film, in a case where the support or other layers have poor heat resistance, for example, the method described in JP2008-159824A may be used.

In addition, the insulating layer preferably has a single layer configuration of an inorganic layer containing polysilazane, which is a silicon nitride. In this case, the polysilazane is in the form of a cured product.

The inorganic layer containing polysilazane may have a configuration in which, for example, a silicon oxynitride (SiON) is contained on the surface. The method for forming the inorganic layer containing polysilazane will be described later.

The polysilazane is a polymer having two or more repeating units of (—Si—N—), and in this chemical formula, a hydrogen atom or an organic group (such as an alkyl group) may be bonded to the remaining two bonding sites of the silicon atom (tetravalent), and the remaining one bonding site of the nitrogen atom (trivalent).

In addition, the polysilazane may be not only a polymer having a linear structure consisting only of the above-mentioned repeating unit, but also may have a cyclic structure formed by bonding one or both of the remaining two bonding sites of the silicon atom to the bonding site of the nitrogen atom. The polymer may consist only of repeating cyclic structures, or may be a linear polymer having a cyclic structure in a part thereof.

In addition, an inorganic layer having a composition different from that of the insulating layer, or a resin layer may be provided adjacent to the insulating layer, or in a case where two or more insulating layers are provided, may be provided to be sandwiched between two insulating layers. In particular, it is preferable to provide a thin film layer of a resin from the viewpoint of imparting resistance to bending. The properties required for such a resin are preferably a low permittivity, a low dielectric loss tangent, and low hygroscopicity, and are preferably high transmittance to visible light. A polyolefin, a cyclo-olefin polymer, a polyacrylate, a polycarbonate, a polyamide, a polyimide, or the like is known as the material of such a resin. The material having high flexibility is particularly preferable, and a polyolefin, a cyclo-olefin polymer, a polyacrylate, a fluorine-containing polyimide, or the like is suitably used. From the viewpoint of improving resistance to bending, the thickness of each of the thin film layers of a resin is preferably in a range of 0.2 to 5 μm, and more preferably in a range of 0.5 to 2.5 μm. In a case where the thickness of each of the thin film layers of a resin is within the above-mentioned range, in addition to being able to be made thin, an effect of dispersing bending stress and an effect of minimizing a difference in change in curvature for each layer can be obtained at the same time, so high bending resistance can be imparted.

### <Transparent Electrode Layer>

The transparent electrode layer functions as a common electrode for driving an electrophoretic ink composition or a liquid crystal composition filled in a plurality of concave portions of the structure layer. The transparency of the transparent electrode layer is as described above.

For example, indium tin oxide (ITO), nitrogen (n)-doped In₂O₃, crystalline ITO, amorphous ITO, fluorine (F)-doped In₂O₃ (IFO), tin oxide (SnO₂), antimony (Sb)-doped SnO₂ (ATO), fluorine (F)-doped SnO₂ (FTO), aluminum (Al)-doped ZnO, boron (B)-doped ZnO, gallium (Ga)-doped ZnO, indium zinc oxide (IZO), titanium oxide (TiO₂), a spinel-type oxide, and an oxide having a YbFe₂O₄ structure can be used as the material constituting the transparent electrode layer. In addition to these materials, conductive polymers such as polyaniline, polypyrrole, and polythiophene can also be used as the material constituting the transparent electrode layer.

Examples of the method for forming the transparent electrode layer include physical vapor deposition (PVD) methods such as a vacuum vapor deposition method, a reactive vapor deposition method, a sputtering method, an electron beam vapor deposition method, and an ion plating method. In addition to these methods, other examples of the method for forming the transparent electrode layer include a chemical vapor deposition (CVD) method including a metal organic chemical vapor deposition (MOCVD) method, a pyrosol method, a method of thermally decomposing an organic metal compound, a spray method, a dip method, an electroless plating method, and an electrolytic plating method. In addition to these methods, a coating method or a method of mixing a conductive agent with a solvent or a synthetic resin binder and applying the mixture can be used as the method for forming the transparent electrode layer.

### <Structure Layer>

The structure layer constitutes pixels for obtaining a display image. The structure layer constitutes, for example, a part of electronic paper which is a display device. As described above, a plurality of concave portions are filled with, for example, an electrophoretic ink composition.

For example, ink compositions described in JP2010-210812A, JP2013-174821A, JP2014-21176A, JP2014-77968A, and JP2017-15901A can be used as the electrophoretic ink composition.

The structure layer is composed of a resin material that is transparent to visible light. Therefore, a display image composed of pixels can be visually recognized.

Specific examples of the resin material that is transparent to visible light include an acrylic resin, polycarbonate, polyurethane, an epoxy resin, a melamine resin, polyamide, polyimide, polysulfonamide, polysulfinate, polyvinyl acetate, a phenol resin, polyolefin, a cyclo-olefin polymer, and polybutadiene. The materials described in JP2017-58581A, JP2013-235063A, and JP2003-208107A can also be suitably used as the resin material that is transparent to visible light.

In addition, the resin material that is transparent to visible light does not mean that the structure layer itself is transparent to visible light, but that the resin material used for manufacturing the structure layer is transparent to visible light.

The method for forming the structure layer is not particularly limited, and examples thereof include a lithography method, a three-dimensional (3D) printing method, a self-organization method, and an imprinting method. Among these methods, an imprinting method is preferable from the viewpoint of excellent productivity, and for example, the method for forming a concave-convex shape described in paragraph of WO2018/084289A can be preferably used.

As described above, the structure layer 18 has a plurality of concave portions 21 that are configured to be surrounded by the partition walls 19b. A surface 19d of the base 19a corresponds to the bottom surface 21b of the concave portion 21. The surface 19d of the base 19a is plane, and the bottom surface 21b of the concave portion 21 is also plane.

Here, FIG. 5 is a schematic view showing an example of a pattern of the partition wall of the structure layer of the laminated structure film according to the embodiment of the present invention. FIG. 5 shows the pattern of the partition wall 19b in a case where the structure layer 18 is viewed from the one surface 12a side of the laminated structure film 10. In FIG. 5, the base 19a of the structure layer 18 is not shown.

For example, as shown in FIG. 5, the shape of the concave portion 21 that is surrounded by the partition wall 19b is a regular hexagon.

Although not shown in FIG. 5, the regular hexagonal concave portions 21 are disposed in a honeycomb pattern on the surface 17b (see FIG. 1) of the transparent electrode layer 17 (see FIG. 1). That is, the partition walls 19b are provided on the surface 17b (see FIG. 1) of the transparent electrode layer 17 (see FIG. 1) in order to constitute the sides of a regular hexagon.

The shape of the concave portion 21 is not limited to a regular hexagon, and may be a triangle, a quadrangle, a circle, or an ellipse. From the viewpoint that the concave portions 21 can be disposed without gaps on a plane, the shape of the concave portion 21 is preferably a regular triangle or a square, other than a regular hexagon.

In addition, in the structure layer, in the concave portion 21, the distance in the thickness direction Dt of the transparent electrode layer 17 from the bottom surface 21b of the concave portion 21 to the end 19c of the partition wall 19b on the side opposite to a bottom surface 21b of the concave portion 21 is preferably 20 to 50 μm. The distance in the thickness direction Dt of the transparent electrode layer 17 from the bottom surface 21b of the concave portion 21 to the end 19c of the partition wall 19b on the side opposite to the bottom surface 21b of the concave portion 21 represents the depth of the concave portion 21.

It is preferable that the distance in the thickness direction Dt of the transparent electrode layer 17 from the bottom surface 21b of the above-mentioned concave portion 21 to the end 19c of the partition wall 19b on the side opposite to the bottom surface 21b of the concave portion 21 is 20 to 50 μm from the viewpoint that the time required for migration can be shortened and the response can be accelerated while ensuring the contrast.

The end 19c of the partition wall 19b on the side opposite to the bottom surface 21b refers to a portion of the partition wall 19b at a position farthest from the bottom surface 21b of the concave portion 21, that is, the surface 19d of the base 19a, in a direction perpendicular to the surface 19d of the base 19a. In the partition wall 19b, the end 19c on the side opposite to the base 19a is plane, and the plane portion is the end 19c. In a case where the end 19c of the partition wall 19b on the side opposite to the base 19a is sharp, the tip of the sharp portion is the end 19c.

The size of the concave portion 21 is, for example, in a range of 2 to 200 μm, more preferably in a range of 5 to 100 μm, and particularly preferably in a range of 10 to 60 μm. In a case where the size of the concave portion 21 is in the above-mentioned range, chipping of the partition wall and unevenness in thickness and size in a case of forming the structure layer can be suppressed, and sufficient resolution can be provided in a case of visual recognition.

In addition, the partition wall 19b has, for example, a trapezoidal cross-sectional shape shown in FIG. 1 in which the end 19c is narrower than the base 19a, but the present invention is not limited thereto. The cross-sectional shape of the partition wall 19b shown in FIG. 1 may be, for example, a triangular shape, a rectangular shape, or a square shape.

With regard to the partition wall 19b, for example, in the cross-sectional shape shown in FIG. 1, the length of the transparent electrode layer 17 in the thickness direction Dt (the thickness of the transparent electrode layer) can be appropriately set depending on the sheet resistance value or the transparency, and is preferably in a range of approximately 100 to 5000 angstroms. In addition, the length of the partition wall 19b in the direction orthogonal to the thickness direction Dt of the transparent electrode layer 17 is preferably in a range of 2 to 200 μm. The direction orthogonal to the thickness direction Dt of the transparent electrode layer 17 is the direction Dw orthogonal to the above-mentioned extending direction DL of the partition wall 19b (see FIG. 5).

With regard to the thickness of each layer constituting the above-mentioned laminated structure film, in a case where there is no particular description, a cross-sectional image of a cross section of the laminated structure film is acquired using a scanning electron microscope, and 10 points are measured at each of the portions corresponding to the thickness of each layer. The average value of each 10 points is taken as the thickness of each layer constituting the laminated structure film.

### (Manufacturing Method of Laminated Structure Film)

Next, a manufacturing method of the laminated structure film 10 will be described.

FIG. 6 to FIG. 10 are schematic cross-sectional views showing an example of the manufacturing method of the laminated structure film according to the embodiment of the present invention in the order of steps. Furthermore, in FIG. 6 to FIG. 10, the same reference numerals are assigned to the same components as those in the image display device 26 shown in FIG. 1, and detailed description thereof will not be repeated.

First, as shown in FIG. 6, the first conductive layer 13 is formed on the one surface 12a of the support 12, and the second conductive layer 14 is formed on the other surface 12b of the support 12.

The first conductive layer 13 and the second conductive layer 14 have, for example, the configuration shown in FIG. 2. As described above, the first conductive layer 13 and the second conductive layer 14 are formed by, for example, a sputtering method, a vapor deposition method, a plating method, a silver salt method, or a printing method.

More specifically, a long PET film having a thickness of 40 μm is prepared as a support, and both surfaces of the support are subjected to a corona discharge treatment to carry out a surface hydrophilization treatment. The first conductive layer 13 and the second conductive layer 14 having a mesh pattern are formed on both surfaces of the support using, for example, the manufacturing method of Example 1 described in JP2020-17381A.

Then, as shown in FIG. 7, the insulating layer 16 covering the second conductive layer 14 is formed on the other surface 12b of the support 12.

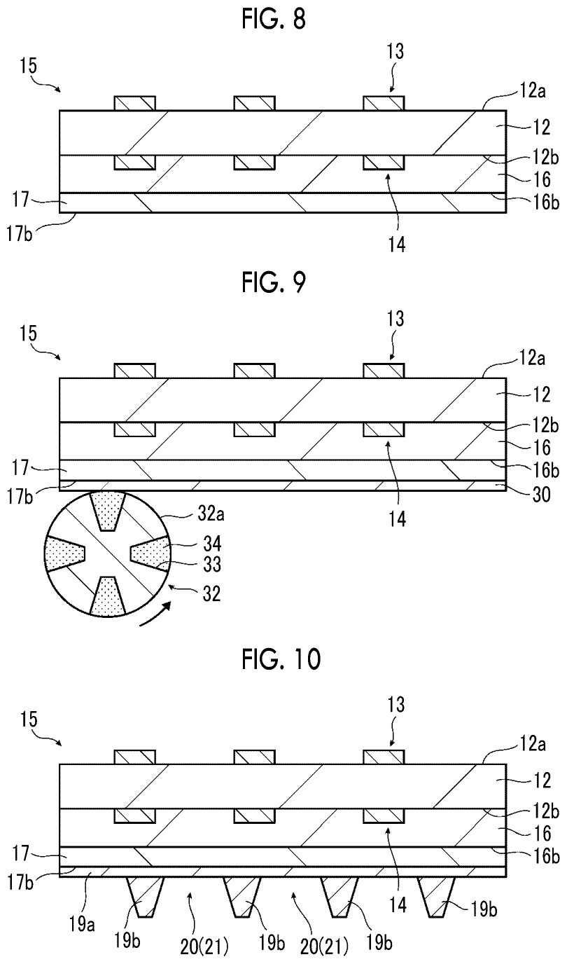

With regard to the formation of the insulating layer 16, for example, a polysilazane compound dissolved in a solvent is applied onto the other surface 12b of the support 12 to cover the second conductive layer 14, and the solvent is partially removed from the applied material by blowing air. Thereafter, in a heated atmosphere, a mixed gas of dried oxygen and nitrogen is irradiated with an ultraviolet lamp to generate ozone, and a gas containing ozone is sprayed onto the applied material. As a result, an inorganic layer having a surface consisting of SiON (silicon oxynitride) and an inside consisting of SiN (silicon nitride) is formed as the insulating layer 16. The surface of the inorganic layer is the side of the insulating layer 16 opposite to the support 12, that is, the surface 16b of the insulating layer 16 on the transparent electrode layer 17 (see FIG. 1 and FIG. 8) side.

Next, although not shown, an ultraviolet curable hard coat layer having a thickness of 0.1 μm is formed on the surface of the inorganic layer, that is, on the surface 16b of the insulating layer 16. The ultraviolet curable hard coat layer is formed, for example, by applying an ultraviolet curable resin onto the surface 16b of the insulating layer 16 and then irradiating the applied ultraviolet curable resin with ultraviolet rays to cure the ultraviolet curable resin.

Next, as shown in FIG. 8, an ITO film having a thickness of 25 nm is formed as the transparent electrode layer 17 on the surface of the ultraviolet curable hard coat layer (not shown) using, for example, a sputtering method.

Next, for example, the following composition is applied onto the surface 17b of the transparent electrode layer 17 to form a coating film 30 as shown in FIG. 9. In a case where the coating film 30 is cured, it becomes the base 19a.

A shaping roll 32 in which concave portions 33 having a shape and a pattern based on the partition walls 19b to be formed and the disposed pattern of the partition walls 19b are provided on a surface 32a thereof is prepared.

Then, the concave portion 33 of the shaping roll 32 is filled with the following composition 34.

Next, while the coating film 30 is wound around the surface 32a of the shaping roll 32 to be in contact with the coating film 30, the coating film 30 is subjected to exposure at an irradiation amount of 500 mJ/cm² using an air-cooled metal halide lamp (manufactured by Eye Graphics Co., Ltd.) with an input power of 200 W/cm from the support 12 side. At this time, the composition 34 in the concave portion 33 of the shaping roll 32 is transferred to the coating film 30 in a shape corresponding to the concave portion 33, followed by exposure. In addition, the coating film 30 is also subjected to exposure. As a result, as shown in FIG. 10, the coating film 30 is cured to form the base 19a, and the transferred composition 34 is cured to form the partition wall 19b, thereby forming the structure layer 18. In this manner, the laminated structure film 10 can be formed.

The concave portion 21 of the structure layer 18 is a regular hexagon having a length of one side of 25 μm. In a case where the structure layer 18 is viewed from one surface 12a side of the laminated structure film 10, the regular hexagonal concave portions 21 are disposed in a honeycomb pattern as shown in FIG. 5.

The distance in the thickness direction of the transparent electrode layer from the bottom surface 21b of the concave portion 21 to the end 19c of the partition wall 19b on the side opposite to the bottom surface 21b of the concave portion 21 is 25 μm. That is, the depth of the concave portion 21 is 25 μm, and the thickness of the partition wall 19b that separates the concave portions 21 from each other is 5 μm at the center of each side of the regular hexagonal shape.

(Composition)

| Urethane (meth)acrylate (U-4HA, | 49 | parts by mass |
|---|---|---|
| manufactured by Shin-Nakamura | | |
| Chemical Co., Ltd.) | | |
| Tricyclodecane dimethanol diacrylate | 49 | parts by mass |
| A-DCP (manufactured by Shin-Nakamura | | |
| Chemical Co., Ltd.) | | |
| Photopolymerization initiator | 2 | parts by mass |

(IRGACURE TPO, manufactured by BASF SE)

### (Applications of Laminated Structure Film)

The above-mentioned laminated structure film 10 can be used for, for example, the image display device 26 shown in FIG. 1 described above.

In addition to this application, for example, the above-mentioned laminated structure film 10 can be used for an active color modulation element having a colorable liquid crystal composition (not shown) filled in the concave portion 21 of the structure layer 18, a sealing layer 22 that seals the opening portion of the concave portion 21 shown in FIG. 1, a drive circuit board 24 provided on the sealing layer 22 side, and a controller (not shown) connected to the first conductive layer 13 and the second conductive layer 14.

The colorable liquid crystal composition may be a liquid crystal composition containing a liquid crystal compound that has absorption in a range of visible light and exhibits dichroism. In addition, the colorable liquid crystal composition may be a liquid crystal composition (so-called host-guest composition) containing a liquid crystal compound that has no absorption in a range of visible light and a non-liquid crystal compound that has absorption in a range of visible light and exhibits dichroism, in which the non-liquid crystal compound is aligned depending on an alignment state of the liquid crystal compound. Any known composition can be used as such a composition.

In addition, the above-mentioned laminated structure film 10 can be used for, for example, an active scattering modulation element including a liquid crystal composition (not shown) filled in the concave portion 21 of the structure layer 18, the sealing layer 22 that seals the opening portion of the concave portion 21 shown in FIG. 1, the drive circuit board 24 provided on the sealing layer 22 side, and a controller (not shown) connected to the first conductive layer 13 and the second conductive layer 14.

In addition, the above-mentioned laminated structure film 10 can be used for, for example, an active micro lens array element including a liquid crystal composition (not shown) filled in the concave portion 21 of the structure layer 18, the sealing layer 22 that seals the opening portion of the concave portion 21 shown in FIG. 1, the drive circuit board 24 provided on the sealing layer 22 side, and a controller (not shown) connected to the first conductive layer 13 and the second conductive layer 14, in which the concave portion 21 has a hemispherical or dome shape.

The present invention is basically configured as described above. Although the laminated structure film according to the embodiment of the present invention has been described in detail above, the present invention is not limited to the above-mentioned embodiments, and various improvements or modifications may be made without departing from the spirit and scope of the present invention.

### EXPLANATION OF REFERENCES

10: laminated structure film
12: support
12a: one surface
12b: the other surface
13: first conductive layer
14: second conductive layer
15: touch sensor
16: insulating layer
16b, 17b: surface
17: transparent electrode layer
18: structure layer
19a: base
19b: partition wall
19c: end
19d: surface
20: region
21: concave portion
21b: bottom surface
22: sealing layer
22b: surface
23: adhesion layer
24: drive circuit board
26: image display device
30: coating film
32: shaping roll
32a: surface
33: concave portion
34: composition
40: detection unit
42: peripheral wiring unit
42a: first peripheral wiring
42b: second peripheral wiring
43: flexible circuit board
44: first detection electrode
45a: first dummy electrode
45b: second dummy electrode
46: second detection electrode
47: first electrode terminal
48: second electrode terminal
49a: first external connection terminal
49b: second external connection terminal
50: conductive thin wires
51: opening portion
Dt: thickness direction
E₁: detection region
E₂: peripheral region
H: thickness

What is claimed is:

1. A laminated structure film comprising:
a support;
a first conductive layer provided on one surface of the support;
a second conductive layer provided on the other surface of the support opposite to the one surface;
an insulating layer provided on the other surface of the support to cover the second conductive layer;
a transparent electrode layer provided on the insulating layer; and
a structure layer provided on the transparent electrode layer,
wherein the first conductive layer and the second conductive layer have a mesh pattern,
the structure layer is composed of a resin material that is transparent to visible light,
the structure layer has a plurality of regions that are partitioned by partition walls and are independent from each other,
the insulating layer includes an inorganic layer composed of an oxide, a nitride, an oxynitride, or a carbonized oxide, each containing an element selected from Si, Al, Ti, and Zr, and
the inorganic layer has a thickness of 0.02 to 2 μm.

2. The laminated structure film according to claim 1,
wherein the insulating layer has a single layer configuration of the inorganic layer containing polysilazane.

3. The laminated structure film according to claim 1,
wherein the inorganic layer contains the oxynitride on a surface thereof.

4. The laminated structure film according to claim 1,
wherein the region of the structure layer is a concave portion that is configured to be surrounded by the partition wall, and
in the concave portion, a distance in a thickness direction of the transparent electrode layer from a bottom surface of the concave portion to an end of the partition wall on a side opposite to the bottom surface is 20 to 50 μm.

5. The laminated structure film according to claim 2,
wherein the inorganic layer contains the oxynitride on a surface thereof.

6. The laminated structure film according to claim 2,
wherein the region of the structure layer is a concave portion that is configured to be surrounded by the partition wall, and
in the concave portion, a distance in a thickness direction of the transparent electrode layer from a bottom surface of the concave portion to an end of the partition wall on a side opposite to the bottom surface is 20 to 50 μm.

7. The laminated structure film according to claim 3,
wherein the region of the structure layer is a concave portion that is configured to be surrounded by the partition wall, and
in the concave portion, a distance in a thickness direction of the transparent electrode layer from a bottom surface of the concave portion to an end of the partition wall on a side opposite to the bottom surface is 20 to 50 μm.
